(19) United States
(12) Patent Application Publication
(10) Pub. No.: US 2025/0299680 A1
(43) Pub. Date: Sep. 25, 2025

(54) IDENTIFYING DEEPFAKE AUDIO USING BREATH DETECTION AND MEASUREMENT

(71) Applicant: University of Florida Research Foundation, Incorporated, Gainesville, FL (US)

(72) Inventors: Patrick G. Traynor, Gainesville, FL (US); Kevin S. Warren, Gainesville, FL (US); Kevin Butler, Gainesville, FL (US); Seth Layton, Gainesville, FL (US); Daniel Olszewski, Gainesville, FL (US); Thiago de Andrade, Gainesville, FL (US); Carrie Gates, Livermore, CA (US)

(21) Appl. No.: 19/083,551

(22) Filed: Mar. 19, 2025

Related U.S. Application Data
(60) Provisional application No. 63/567,568, filed on Mar. 20, 2024.

(51) Int. Cl. G10L 17/26; G10L 17/02; G10L 17/06; G10L 25/09; G10L 25/18

(52) U.S. Cl. CPC G10L 17/26; G10L 17/02; G10L 17/06; G10L 25/09; G10L 25/18

(57) ABSTRACT

Various embodiments of the present disclosure provide for identifying deepfake audio using breath detection and measurement. In one example, an embodiment provides for extracting one or more audio features from an audio sample, applying a breath detection model to the one or more audio features to determine one or more breath events associated with the audio sample, and identifying the audio sample as a deepfake audio sample or an organic audio sample by applying a machine learning model to the one or more breath events.

### CROSS-REFERENCE TO RELATED APPLICATIONS

This application claims the benefit of U.S. Provisional Patent Application No. 63/567,568, titled “IDENTIFYING DEEPFAKE AUDIO USING BREATH DETECTION AND MEASUREMENT,” and filed on Mar. 20, 2024, which is incorporated herein by reference in its entirety.

### GOVERNMENT SUPPORT

This invention was made with government support under N00014-21-1-2658 awarded by the US NAVY OFFICE OF NAVAL RESEARCH. The government has certain rights in the invention.

### TECHNICAL FIELD

The present application relates to the technical field of audio processing, computer security, electronic privacy, and/or machine learning. In particular, the invention relates to performing audio processing and/or machine learning modeling to distinguish between organic audio produced based on a human's voice and synthetic “deepfake” audio produced digitally.

### BACKGROUND

Recent advances in voice synthesis and voice manipulation techniques have made generation of “human-sounding” but “never human-spoken” synthetic audio possible. Such technical advances can be employed for various applications such as, for example, for providing patients with vocal loss the ability to speak, for creating digital avatars capable of accomplishing certain types of tasks such as making reservation to a restaurant, etc. However, these technical advances also have potential for misuse, such as, for example, when synthetic audio mimicking a voice of a user is generated without consent by the user. Unauthorized synthetic audio such as, for example, synthetic voices are known as “audio deepfakes.”

### SUMMARY

In general, embodiments of the present invention provide methods, apparatus, systems, computing devices, computing entities, and/or the like for identifying deepfake audio using breath detection and/or breath measurement. The details of some embodiments of the subject matter described in this specification are set forth in the accompanying drawings and the description below. Other features, aspects, and advantages of the subject matter will become apparent from the description, the drawings, and the claims.

In an embodiment, a method for detecting audio deepfakes using breath events is provided. In one or more embodiments, the method provides for extracting one or more audio features from an audio sample, the one or more audio features indicative of one or more breath characteristics associated with human speech. In one or more embodiments, the method additionally or alternatively provides for applying a breath detection model to the one or more audio features to determine one or more breath events associated with the audio sample. In one or more embodiments, the method additionally or alternatively provides for identifying the audio sample as a deepfake audio sample or an organic audio sample by applying, to the one or more breath events, a machine learning model configured as a classification-based detector for audio deepfakes.

In another embodiment, an apparatus for detecting audio deepfakes using breath events is provided. The apparatus comprises at least one processor and at least one memory including program code. In one or more embodiments, the at least one memory and the program code is configured to, with the at least one processor, cause the apparatus to extract one or more audio features from an audio sample, the one or more audio features indicative of one or more breath characteristics associated with human speech. In one or more embodiments, the at least one memory and the program code is additionally or alternatively configured to, with the at least one processor, cause the apparatus to apply a breath detection model to the one or more audio features to determine one or more breath events associated with the audio sample. In one or more embodiments, the at least one memory and the program code is additionally or alternatively configured to, with the at least one processor, cause the apparatus to identify the audio sample as a deepfake audio sample or an organic audio sample by applying, to the one or more breath events, a machine learning model configured as a classification-based detector for audio deepfakes.

In yet another embodiment, a non-transitory computer storage medium comprising instructions for detecting audio deepfakes using breath events is provided. In one or more embodiments, the instructions are configured to cause one or more processors to at least perform operations configured to extract one or more audio features from an audio sample, the one or more audio features indicative of one or more breath characteristics associated with human speech. In one or more embodiments, the instructions are additionally or alternatively configured to cause one or more processors to at least perform operations configured to apply a breath detection model to the one or more audio features to determine one or more breath events associated with the audio sample. In one or more embodiments, the instructions are additionally or alternatively configured to cause one or more processors to at least perform operations configured to identify the audio sample as a deepfake audio sample or an organic audio sample by applying, to the one or more breath events, a machine learning model configured as a classification-based detector for audio deepfakes.

### BRIEF DESCRIPTION OF THE DRAWINGS

Reference will now be made to the accompanying drawings, which are not necessarily drawn to scale, and wherein:

FIG. 1 illustrates a system for detecting audio deepfakes using breath events, according to one or more embodiments of the present disclosure;

FIG. 2 illustrates an example visual representation for a segment of speech containing a speech event, according to one or more embodiments of the present disclosure;

FIG. 3 illustrates an example spectrogram associated with an organic audio sample and an example spectrogram associated with a deepfake audio sample, according to one or more embodiments of the present disclosure;

FIG. 4 illustrates an example model architecture for a synthetic speech detection model, according to one or more embodiments of the present disclosure;

FIG. 5 illustrates accuracy and improved performance of a synthetic speech detection model in correctly identifying deepfake attacks, according to one or more embodiments of the present disclosure;

FIG. 6 is a flowchart of a method for detecting audio deepfakes using breath events according to one or more embodiments of the present disclosure;

FIG. 7 is a flowchart of a method for training a machine learning model for detecting audio deepfakes according to one or more embodiments of the present disclosure; and

FIG. 8 illustrates a schematic of a computing entity that may be used in conjunction with one or more embodiments of the present disclosure.

### DETAILED DESCRIPTION

The present disclosure more fully describes various embodiments with reference to the accompanying drawings. It should be understood that some, but not all embodiments are shown and described herein. Indeed, the embodiments may take many different forms, and accordingly this disclosure should not be construed as limited to the embodiments set forth herein. Rather, these embodiments are provided so that this disclosure will satisfy applicable legal requirements. Like numbers refer to like elements throughout.

Recent advances in voice synthesis and voice manipulation techniques have made generation of “human-sounding” but “never human-spoken” audio possible. Such technical advances can be employed for various applications such as, for example, for providing patients with vocal loss the ability to speak, for creating digital avatars capable of accomplishing certain types of tasks such as making reservation to a restaurant, etc. However, these technical advances also have potential for misuse, such as, for example, when synthetic audio mimicking a voice of a user is generated without consent by the user. Unauthorized synthetic audio such as, for example, synthetic voices are known as “audio deepfakes.”

Audio deepfakes are a digitally produced speech sample (e.g., a synthesized speech sample) that is intended to sound like a specific individual. Currently, audio deepfakes are often produced via the use of machine learning algorithms. While there are numerous audio deepfake machine learning algorithms in existence, generation of audio deepfakes generally involves an encoder, a synthesizer, and/or a vocoder. The encoder generally learns the unique representation of the speaker's voice, known as the speaker embedding. These can be learned using a model architecture similar to that of speaker verification systems. The speaker embedding can be derived from a short utterance using the target speaker's voice. The accuracy of the speaker embedding can be increased by giving the encoder more utterances. The output embedding from the encoder can be provided as an input into the synthesizer. The synthesizer can generate a spectrogram such as, for example, a Mel spectrogram from a given text and the speaker embedding. A Mel spectrogram is a spectrogram that comprises frequencies scaled using the Mel scale, which is designed to model audio perception of the human ear. Some synthesizers are also able to produce spectrograms solely from a sequence of characters or phonemes. The vocoder can convert the Mel spectrogram to retrieve the corresponding audio waveform. This newly generated audio waveform will ideally sound like a target individual uttering a specific sentence. A commonly used vocoder model employs a deep convolutional neural network generates a waveform based on surrounding contextual information.

While audio deepfake quality has substantially improved in recent years, audio deepfakes remain imperfect as compared to organic audio produced based on a human's voice. As such, technical advances related to detecting audio deepfakes have been developed using bi-spectral analysis (e.g., inconsistencies in the higher order correlations in audio) and/or by employing machine learning models trained as discriminators. However, audio deepfakes detection techniques and/or audio deepfake machine learning models are generally dependent on specific, previously observed generation techniques. For example, audio deepfakes detection techniques and/or audio deepfake machine learning models generally exploit low-level flaws (e.g., unusual spectral correlations, abnormal noise level estimations, and unique cepstral patterns, etc.) related to synthetic audio and/or artifacts of deepfake generation techniques to identify synthetic audio.

However, synthetic voices (e.g., audio deepfakes) are increasingly indifferentiable from organic human speech, often being indistinguishable from organic human speech by authentication systems and human listeners. For example, with recent advancements related to audio deepfakes, low-level flaws are often removed from an audio deepfake. Moreover, synthetic speech represents a real and growing threat to various technological systems. While numerous synthetic audio detectors have been created to aid in defense against synthetic audio, these synthetic audio detectors typically rely on low-level fragments of the speech generation process. For example, typical synthetic audio detectors utilize low-level spectral (e.g., spectrogram, MFCC, LFCC, and CQCC) imperfections created during an audio generation pipeline to detect synthetic audio. This technique of low-level spectral detection, however, is soon to be rendered obsolete due to the rapid technological advancement of speech generation and/or artificial intelligence technologies. As such, improved audio deepfakes detection techniques and/or improved audio deepfake machine learning models are desirable to more accurately identify a voice audio source as a human voice or a synthetic voice (e.g., a machine-generated voice).

To address these and/or other issues, various embodiments described herein relate to detecting audio deepfakes using breath detection and/or breath measurement associated with audio. For example, improved audio deepfakes detection techniques and/or improved audio deepfake machine learning models that utilize synthetic speech detection using breath events can be provided. The breath events can be related to a higher-level part of speech as compared to a lower-level of speech. For example, since breathing is one of the subtle ways that humans subconsciously perceive naturalness in speech, breath events can be utilized for high-level speech feature exploration for audio deepfake detection. As such, the breath events can be utilized as a detection mechanism (e.g., a performant discriminator) related to audio deepfakes. In various embodiments, the detection mechanism can be a generation-agnostic synthetic speech detector based on breath events. For example, the detection mechanism can utilize a classification-based detector for detecting audio deepfakes using breath events. A breath event can be related to a set of audio features such as breath measurements, raw values of a Mel-spectrogram (dB converted), a zero crossing rate (ZCR), a root mean squared energy (RMSE), and/or one or more other audio features. By employing breath events for detecting audio deepfakes as disclosed herein, audio deepfake detection for distinguishing between a human voice or a synthetic voice (e.g., a machine-generated voice) can be provided with improved accuracy as compared to audio deepfake detection techniques that employ bi-spectral analysis and/or machine learning models trained as discriminators.

Exemplary Data Pipeline for Detecting Audio Deepfakes using Breath Events

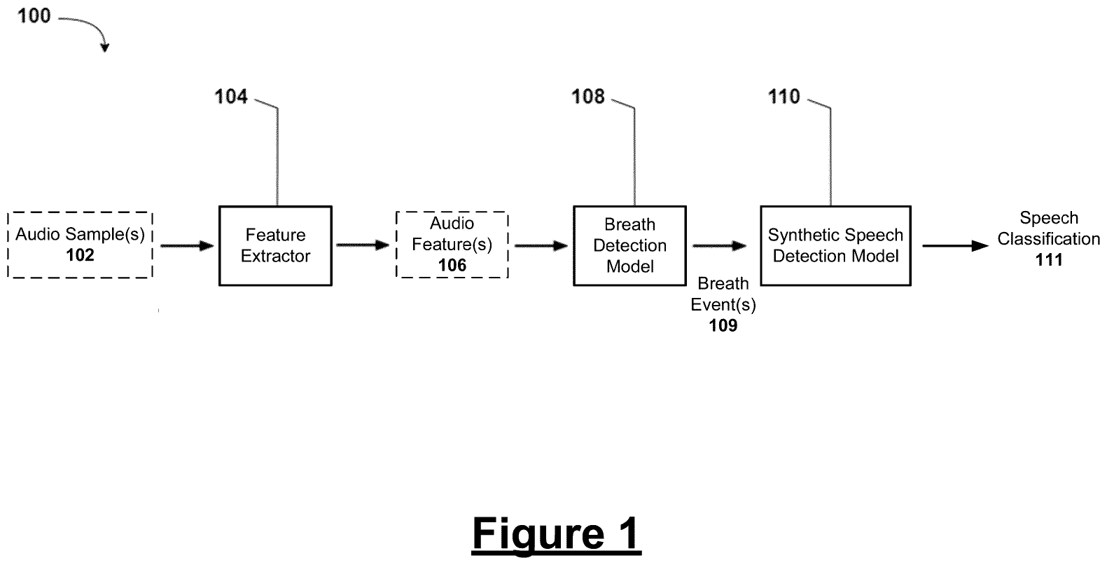

According to various embodiments, a data pipeline for detecting audio deepfakes using breath events is provided. FIG. 1 illustrates a system 100 for detecting audio deepfakes using breath events according to one or more embodiments of the present disclosure. In various embodiments, the system 100 corresponds to a data pipeline that processes audio features of human speech samples and provides the audio features to a breath detection model. The breath detection model can determine one or more breath events based on the audio features. Additionally, the one or more breath events can be provided as input to a machine learning model trained to classify deepfake audio.

The system 100 includes a feature extractor 104, breath detection model 108, and/or synthetic speech detection model 110. In one or more embodiments, the feature extractor 104 receives one or more audio samples 102. In certain embodiments, the one or more audio samples 102 can be one or more speech samples associated with human speech. The feature extractor 104 can process the one or more audio samples 102 to determine one or more audio features 106 associated with the one or more audio samples 102. The one or more audio features 106 can be configured as a feature set F for the breath detection model 108. In one or more embodiments, the one or more audio features 106 can include one or more breath measurement features, one or more Mel-spectrogram features, one or more ZCR features, one or more RMSE features, and/or one or more other audio features. Additionally or alternatively, the one or more audio features 106 can include one or more prosody features, one or more pitch features, one or more pitch variance features, one or more pitch rate of change features, one or more pitch acceleration features, one or more intonation features (e.g., one or more peaking intonation features and/or one or more dipping intonation features), one or more vocal jitter features, one or more fundamental frequency features, one or more vocal shimmer features, one or more rhythm features, one or more stress features, one or more harmonic to noise ratio (HNR) features, one or more metrics features related to vocal range, and/or one or more other prosody features related to the one or more audio samples 102.

In an embodiment, at least a portion of the one or more audio features 106 can be measured features associated with the one or more audio samples 102. For example, the feature extractor 104 can measure at least a portion of the one or more audio features 106 using one or more audio analysis techniques and/or one or more statistical analysis techniques associated with synthetic voice detection. In certain embodiments, the feature extractor 104 can measure at least a portion of the one or more audio features 106 using one or more acoustic analysis techniques that derive audio features from a time-based audio sequence. Additionally, in various embodiments, at least a portion of the one or more audio features 106 can correspond to parameters that can be utilized to classify breath events and/or breath locations in the one or more audio samples 102.

In various embodiments, the one or more audio samples 102 can be configured as respective spectrograms. Additionally the feature extractor 104 can extract raw values computed from the spectrograms to generate the one or more audio features 106. In certain embodiments, the respective spectrograms can be related to a particular window and/or hop length (e.g., a 20 ms window and a 2.5 ms hop length) of an audio sample.

In one or more embodiments, the one or more audio features 106 can be provided as input to the breath detection model 108. The breath detection model 108 can be a machine learning model configured and/or trained for breath event detection based on audio features. For example, the breath detection model 108 can determine one or more breath events 109 related to the one or more audio samples 102 based on the one or more audio features 106. In various embodiments, dimensionality of machine learning layers of the breath detection model 108 can be minimized to reduce model complexity, increase the computing speed for training, and/or to increase the computing speed for providing inferences. In various embodiments, the machine learning layers and/or tuning of related parameters can be optimized for the breath detection model 108 to improve real-time predictions (e.g., determination of the one or more breath events 109) related to the one or more audio samples 102.

In one or more embodiments, the one or more breath events 109 can correspond to and/or include one or more breath locations (e.g., one or more predicted breath locations) within the one or more audio samples 102. Additionally or alternatively, the one or more breath events 109 can include one or more breath event features. In one or more embodiments, the one or more breath event features can be determined based on the one or more breath locations. The one or more breath event features can be associated with average breaths per an interval of time, average breath duration, average spacing between breaths, and/or one or more other characteristics associated with breath locations. In an example, for an audio sample 102, the one or more breath event features can include average breaths per minute, average breath duration, and/or average spacing between breaths.

In a non-limiting example, the breath detection model 108 includes two 1D convolutional layers (e.g., 16 and 8 filters, 3 and 1 kernel sizes, same padding, and ReLU activation) where the respective convolutional layer are followed by batch normalization, max pooling (e.g., a pool size of 3), and/or a dropping out unit (e.g., regularization related to 0.2 dropout of neurons). Additionally, these layers can be utilized as input to a Long short-term memory (LSTM) layer (e.g., a bidirectional-LSTM layer) which feeds into a dense layer with a sigmoid activation for the final prediction related to the one or more breath events 109. In various embodiments, the breath detection model 108 can utilize a binary cross-entropy loss for loss and/or adaptive moment estimator (Adam) optimizer functions.

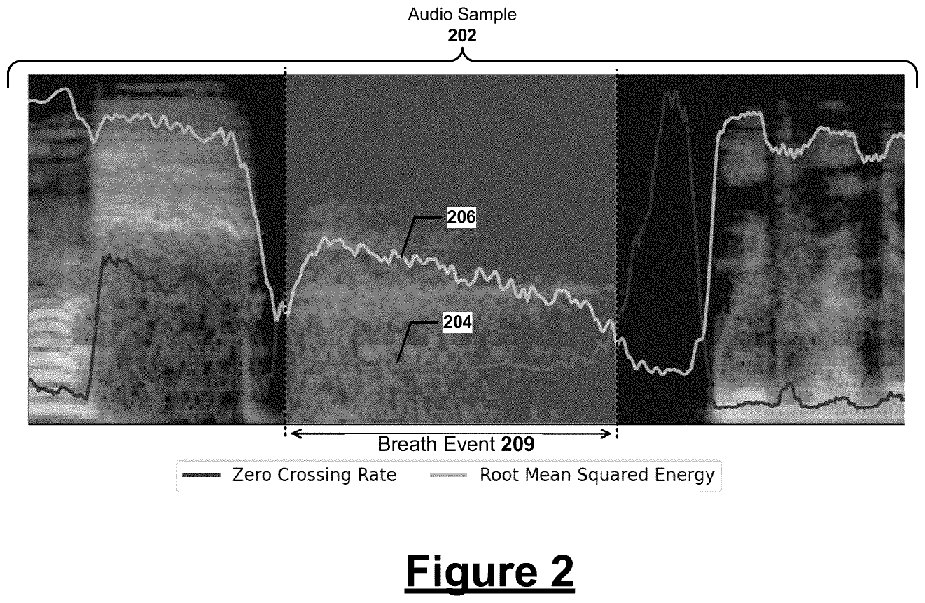

FIG. 2 illustrates a visual representation for a segment of speech containing a speech event according to one or more embodiments of the present disclosure. In this regard, FIG. 2 includes an audio sample 202. The audio sample 202 can correspond to at least a portion of an audio sample from the one or more audio samples 102. In one or more embodiments, the audio sample 202 can be represented as a Mel-spectogram. In one or more embodiments, the feature extractor 104 can calculate raw values of the Mel-spectrogram, ZCR, and/or RMSE based on the audio sample 202. For example, the feature extractor 104 can determine features 204 related to a zero crossing rate during an interval of time of the audio sample 202. Additionally or alternatively, the feature extractor 104 can determine features 206 related to a root mean squared energy during the interval of time of the audio sample 202. As illustrated in FIG. 2, the features 204 related to a zero crossing rate and the features 206 related to a root mean squared energy can change during a breath and speaking before/after breathing. For example, during breaths, the features 204 related to a zero crossing rate and the features 206 related to a root mean squared energy tend towards medium values between silence and spoken segments and the Mel-spectrogram provides only energy at lower frequencies. In other words, during the spoken segments in the audio sample 202 before and after the breath, the features 206 related to a root mean squared energy are at peak values while the features 204 related to a zero crossing rate are at minimum values. Additionally, immediately surrounding a breath is a non-voiced segment where the values of the features 206 related to a root mean squared energy drop and the values of the features 204 related to a zero crossing rate rise, but then both the features 204 related to a zero crossing rate and the features 206 related to a root mean squared energy move toward a medium value during a breath event 209. Additionally, the background Mel spectrogram can provide higher energy across all frequencies during spoken segments, medium energy at lower frequencies during breaths, and relatively little energy at all frequencies for silence during the audio sample 202. As such, the breath detection model 108 can determine the breath event 209 that corresponds to a portion of the audio sample 202 where the features 204 related to a zero crossing rate and/or the features 206 related to a root mean squared energy are determined to change during a breath. For example, the breath event 209 can correspond to a breath location within the audio sample 202.

In a non-limiting example, the feature extractor 104 can determine the features 204 related to a zero crossing rate and the features 206 related to a root mean squared energy for the entire audio sample 202. Additionally, the feature extractor 104 can partition the features 204 and the features 206 into two-second data chunks that are respectively provided as input to the breath detection model 108. For example, a two-second data chunk can include 800 2.5 ms slices of features. Additionally, a Mel-spectogram can provide 128 values and one feature from each of the ZCR and RMSE to provide a total of 130 features. The shape of the features (32×800×130) can be given as input to the breath detection model 108 with a batch size of 32. The breath detection model 108 can provide breath event predictions, for example, for every 50 ms (e.g., 40 predictions per 2-second chunk). For example, the output for a two-second data chunk of audio can be 40 sequential binary classifications as to whether or not there is a breath located in a 50 ms slice. In various embodiments, the breath detection model 108 can invert a prediction if the two surrounding predictions are the opposite class. Additionally or alternatively, the breath detection model 108 can remove any predicted breaths that are shorter than a defined interval of time such as, for example, 100 ms.

Returning to FIG. 1, in one or more embodiments, the one or more breath events 109 determined by the breath detection model 108 can be provided as input to the synthetic speech detection model 110. For example, the one or more breath events 109 can be provided as input features for the synthetic speech detection model 110. The synthetic speech detection model 110 can utilize the one or more breath events 109 to discriminate between real/synthetic speech samples associated with the one or more audio samp. In various embodiments, the one or more breath events 109 can correspond to predicted breath locations within the one or more audio samples 102. The synthetic speech detection model 110 can be a machine learning model configured and/or trained for speech classification related to synthetic speech detection. For example, the synthetic speech detection model 110 can determine a speech classification 111 related to the one or more audio samples 102 based on the one or more breath events 109. In an embodiment, the synthetic speech detection model 110 can be a classifier model. For example, the synthetic speech detection model 110 can be a classification-based detector. In certain embodiments, the synthetic speech detection model 110 can be a neural network model or another type of deep learning model. In certain embodiments, the synthetic speech detection model 110 can be a multilayer perceptron (MLP) such as, for example, a multi-layer perceptron-based classifier. In certain embodiments, the synthetic speech detection model 110 can be a logistic regression model. In certain embodiments, the synthetic speech detection model 110 can be a k-nearest neighbors (kNN) model. In certain embodiments, synthetic speech detection model 110 can be a random forest classifier (RFC) model. In certain embodiments, the synthetic speech detection model 110 can be a support vector machine (SVM) model. In certain embodiments, the synthetic speech detection model 110 can be a deep neural network (DNN) model. In certain embodiments, the synthetic speech detection model 110 can be configured with a SVC (e.g., a C-SVC) algorithm that utilizes a cost parameter C for detecting synthetic speech. For example, the SVC (e.g., a C-SVC) algorithm can be configured with a poly kernel, a regularization parameter of 1, and a degree of 2 to obtain the speech classification 111 for the one or more audio samples 102. However, it is to be appreciated that, in certain embodiments, the synthetic speech detection model 110 can be a different type of machine learning model configured for classification-based detection between audio deepfake samples and organic audio samples associated with human speech.

In certain embodiments, the synthetic speech detection model 110 can include a set of hidden layers configured for classification-based detection between audio deepfake samples and organic audio samples associated with human speech. In certain embodiments, a grid search can be employed to determine an optimal number of hidden layers for the synthetic speech detection model 110 during training of the synthetic speech detection model 110. In certain embodiments, the synthetic speech detection model 110 can include one or more hidden layers. In certain embodiments, respective hidden layers of the synthetic speech detection model 110 can additionally employ a Rectified Linear Unit (ReLU) configured as an activation function and/or a dropout layer configured with a defined probability. In certain embodiments, respective hidden layers of the synthetic speech detection model 110 can comprise a dense layer with a certain degree of constraint on respective weights.

In one or more embodiments, the synthetic speech detection model 110 and/or a feature extractor associated with the synthetic speech detection model 110 can utilize the one or more breath events 109 to determine features related to average breaths per minute, average breath duration, and/or average spacing between breaths. In one or more embodiments, the features can be provided as input to the synthetic speech detection model 110 to provide the speech classification 111. For example, the synthetic speech detection model 110 can be applied to the breath features (e.g., the features related to average breaths per minute, average breath duration, and/or average spacing between breaths) to identify the audio sample as a deepfake audio sample or an organic audio sample. In some embodiments, the synthetic speech detection model 110 can be configured based on a SVC (e.g., a C-SVC) technique associated with a poly kernel, a regularization parameter of 1, and/or a degree of 2 to provide the speech classification 111. In one or more embodiments, the speech classification 111 can be a single binary prediction for the one or more audio sample 102. For example, the speech classification 111 can provide a deepfake audio prediction (e.g., a positive deepfake audio prediction or a negative deepfake audio prediction) for the one or more audio samples 102.

In one or more embodiments, an output layer of the synthetic speech detection model 110 can be configured as a sigmoid output layer. For example, the output layer of the synthetic speech detection model 110 can be configured as a sigmoid activation function configured to provide a first classification associated with a deepfake audio classification and/or a second classification associated with an organically generated audio classification for the one or more audio samples 102. However, in certain embodiments, it is to be appreciated that the output layer of the synthetic speech detection model 110 can generate an audio sample related to a particular phrase or set of phrases input to the hidden layers of the synthetic speech detection model 110 (e.g., rather than the speech classification 111) to facilitate digital creation of a human being uttering the particular phrase or set of phrases. In certain embodiments, one or more weights, biases, activation function, neurons, and/or another portion of the synthetic speech detection model 110 can be retrained and/or updated based on the speech classification 111. In certain embodiments, an alternate model for classifying the one or more audio samples can be selected and/or executed based on a predicted accuracy associated with the speech classification 111. In certain embodiments, visual data associated with the speech classification 111 can be rendered via a graphical user interface of a computing device.

In one or more embodiments, the breath detection model 108 and the synthetic speech detection model 110 can provide a multi-tiered model pipeline that utilizes independent datasets during respective training phases of the breath detection model 108 and the synthetic speech detection model 110. In certain embodiments, the breath detection model 108 can be trained during one or more training phases based on a training dataset that includes single-speaker podcast audio and/or other audio related to speech. Additionally, the synthetic speech detection model 110 can be trained during one or more training phases based on a training dataset that includes audio related to news articles read by humans and/or other audio related to speech. In various embodiments, the synthetic speech detection model 110 can utilize one or more text-to-speech algorithms for providing a final synthetic speech detection prediction. In various embodiments, a training dataset for the breath detection model 108 and/or the synthetic speech detection model 110 can include audio samples that are sufficiently long to contain a breath. Additionally, a training dataset for the breath detection model 108 and/or the synthetic speech detection model 110 can be annotated with labels indicating breath locations. In certain embodiments, a subset of audio samples utilized for training may be randomly selected as a validation dataset for the breath detection model 108 and/or the synthetic speech detection model 110, while the remaining portion of the audio samples may be utilized as a training dataset for the breath detection model 108 and/or the synthetic speech detection model 110. In certain embodiments, a subset of audio samples may be selected as a training dataset based on a predicted impact on breath detection for the entire portion of audio samples and/or respective speakers in the audio samples.

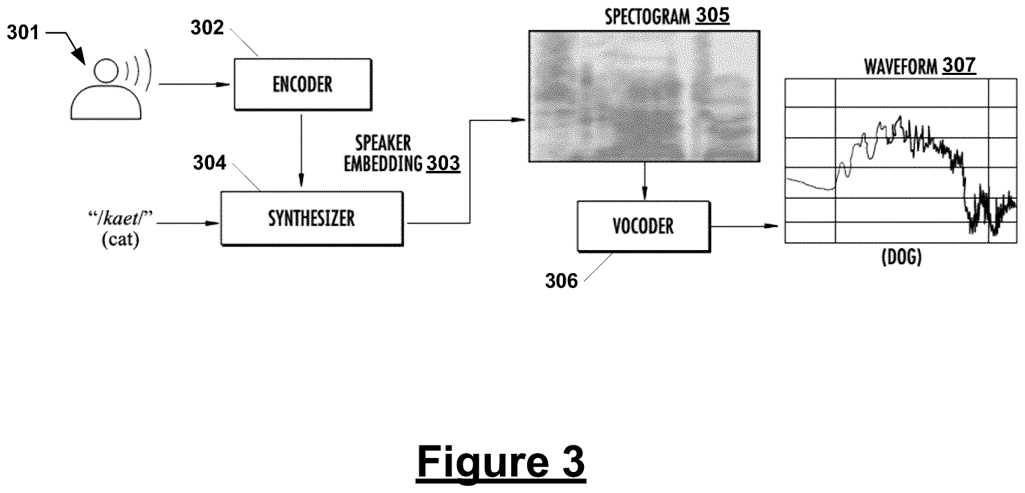

FIG. 3 illustrates an exemplary framework 300 for producing an audio deepfake according to one or more embodiments of the present disclosure. The framework 300 includes three stages: an encoder 302, a synthesizer 304, and vocoder 306.

The encoder 302 learns a unique representation of a voice of a speaker 301, known as a speaker embedding 303. In certain embodiments, these can be learned using a model architecture similar to that of a speaker verification system. The speaker embedding 303 can be derived from a short utterance using the voice of the speaker 301. The accuracy of the speaker embedding 303 can be increased by giving the encoder more utterances, with diminishing returns. The output speaker embedding 303 from the encoder 302 can then be passed as an input into the synthesizer 304.

The synthesizer 304 can generate a spectrogram 305 from a given text and the speaker embedding 303. The spectrogram 305 can be, for example, a Mel spectrogram. For example, the spectrogram 305 can comprise frequencies scaled using the Mel scale, which is designed to model audio perception of the human ear. Some synthesizers are also able to produce spectrograms solely from a sequence of characters or phonemes.

The vocoder 306 converts the spectrogram 305 to retrieve a corresponding waveform 307. For example, the waveform 307 can be an audio waveform associated with the spectrogram 305. This waveform 307 can be configured to sound like the speaker 301 uttering a specific sentence. In certain embodiments, the vocoder 306 can correspond to a vocoder model such as, for example, a WaveNet model, that utilizes a deep convolutional neural network to process surrounding contextual information and to generate the waveform 307. In one or more embodiments, one or more portions of the one or more audio samples 102 can correspond to one or more portions of the waveform 307.

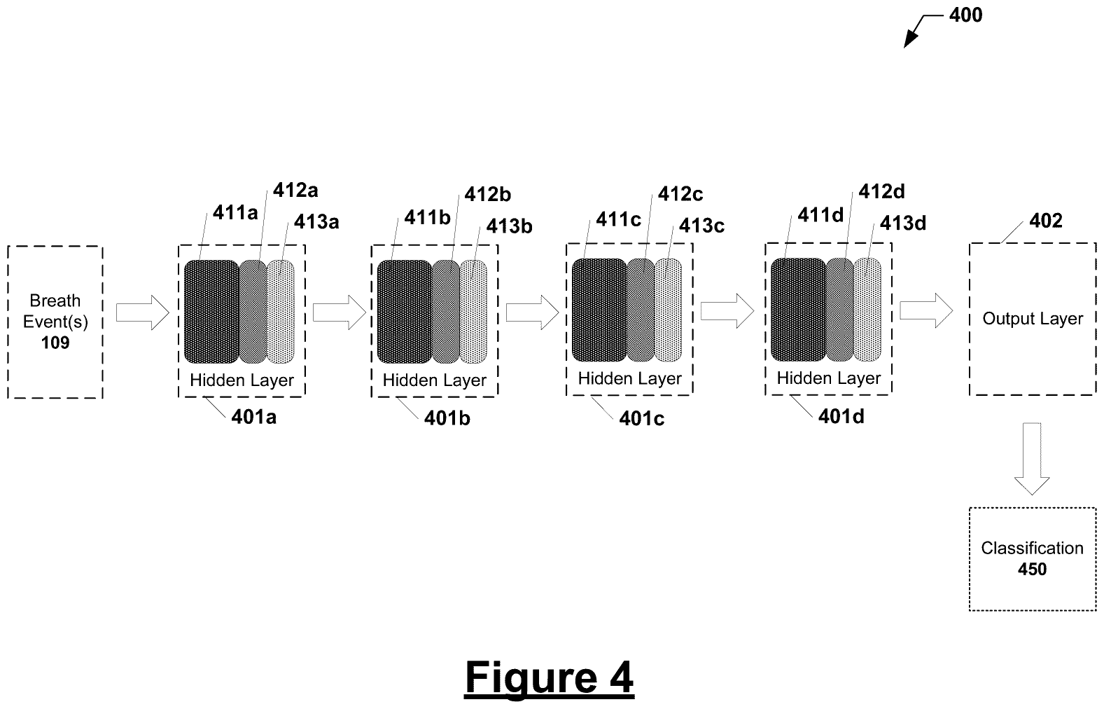

FIG. 4 illustrates an example model architecture 400 accordingly to according to one or more embodiments of the present disclosure. In one or more embodiments, the model architecture 400 can correspond to a model architecture for the synthetic speech detection model 110. In one or more embodiments, the model architecture 400 can be configured as an MLP model. The model architecture 400 can be configured as a classification-based model to classify audio samples of human speech as deepfake audio or organically generated audio. For example, the model architecture 400 can classify the one or more audio samples 102 as deepfake audio or organically generated audio. However, in an alternate embodiment, the model architecture 400 can be configured as an adversary model to generate an audio sample representing, for example, a human being uttering a specific phrase or set of phrases.

In the example embodiment illustrated in FIG. 4, the model architecture 400 includes a first hidden layer 401a, a second hidden layer 401b, a third hidden layer 401c, a fourth hidden layer 401d, and/or an output layer 402. In one or more embodiments, the one or more breath events 109 are provided as input to the first hidden layer 401a. The one or more breath events 109 provided as input to the first hidden layer 401a can correspond to a version of the one or more audio samples 102 that have undergone processing by the feature extractor 104 and/or the breath detection model 108. In some embodiments, the version of the one or more breath events 109 provided as input to the first hidden layer 401a can correspond to a scaled version of the one or more breath events 109 associated with the one or more audio samples 102. In one or more embodiments, the first hidden layer 401a, the second hidden layer 401b, the third hidden layer 401c, and the fourth hidden layer 401d can respectively apply a particular set of weights to one or more inputs related to the one or more breath events 109. For example, the first hidden layer 401a, the second hidden layer 401b, the third hidden layer 401c, and the fourth hidden layer 401d can respectively apply a nonlinear transformation to one or more inputs related to the one or more breath events 109 based a particular set of weights of the respective hidden layer.

In certain embodiments, the first hidden layer 401a can include a dense layer 411a configured with size 64 (e.g., 64 fully connected neuron processing units), the second hidden layer 401b can include a dense layer 411b configured with size 32 (e.g., 32 fully connected neuron processing units), the third hidden layer 401c can include a dense layer 411c configured with size 32 (e.g., 32 fully connected neuron processing units), and the fourth hidden layer can include a dense layer 411d configured with size 16 (e.g., 16 fully connected neuron processing units). For example, the dense layer 411a, the dense layer 411b, the dense layer 411c, and the dense layer 411d can respectively apply a particular set of weights, a particular set of biases, and/or a particular activation function to one or more portions of the one or more breath events 109. Additionally or alternatively, the first hidden layer 401a can include an ReLU 412a, the second hidden layer 401b can include an ReLU 412b, the third hidden layer 401c can include an ReLU 412c, and/or the fourth hidden layer 401d can include an ReLU 412d. For example, the ReLU 412a, the ReLU 412b, the ReLU 412c, and the ReLU 412d can respectively apply a particular activation function associated with a threshold for one or more portions of the one or more breath events 109. Additionally or alternatively, the first hidden layer 401a can include a dropout layer 413a, the second hidden layer 401b can include a dropout layer 413b, the third hidden layer 401c can include a dropout layer 413c, and/or the fourth hidden layer 401d can include a dropout layer 413d. In an example, the dropout layer 413a, the dropout layer 413b, the dropout layer 413c, and/or the dropout layer 413d can be configured with a particular probably value (e.g., P=0.25, etc.) related to a particular node of a respective hidden layer being excluded for processing of one or more portions of the one or more breath events 109.

The output layer 402 can provide a classification 450 for the one or more audio samples 102 based on the one or more machine learning techniques applied to the one or more breath events 109 via the first hidden layer 401a, the second hidden layer 401b, the third hidden layer 401c, and/or the fourth hidden layer 401d. For example, the output layer 402 can provide the classification 450 for the one or more audio samples 102 as either deepfake audio or organically generated audio. Accordingly, the classification 450 can be a deepfake audio prediction for the one or more audio samples 102. In one or more embodiments, the output layer 402 can be configured as a sigmoid output layer. For example, the output layer 402 can be configured as a sigmoid activation function configured to provide a first classification associated with a deepfake audio classification and/or a second classification associated with an organically generated audio classification for the one or more audio samples 102. However, in certain embodiments, it is to be appreciated that the output layer 402 can generate an audio sample related to a particular phrase or set of phrases input to the first hidden layer 401a, the second hidden layer 401b, the third hidden layer 401c, and/or the fourth hidden layer 401d (e.g., rather than the classification 450) to facilitate digital creation of a human being uttering the particular phrase or set of phrases. In certain embodiments, one or more weights, biases, activation function, neurons, and/or another portion of the first hidden layer 401a, the second hidden layer 401b, the third hidden layer 401c, and/or the fourth hidden layer 401d can be retrained and/or updated based on the classification 450. In certain embodiments, an alternate model for classifying the one or more audio samples can be selected and/or executed based on a predicted accuracy associated with the classification 450. In certain embodiments, visual data associated with the classification 450 can be rendered via a graphical user interface of a computing device.

Exemplary Performance of Synthetic Speech Detection Modeling using Breath Events

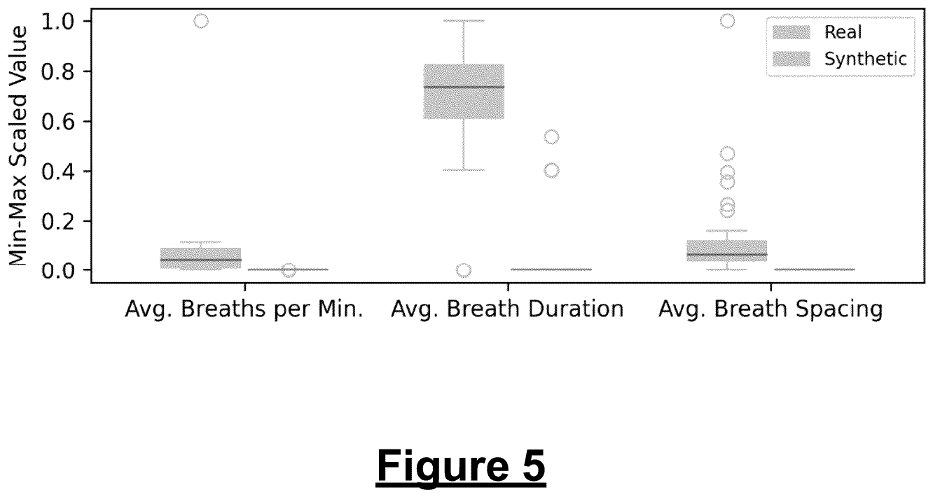

FIG. 5 illustrates accuracy and improved performance of the synthetic speech detection model 110 in correctly identifying deepfake attacks according to one or more embodiments of the present disclosure. As illustrated in FIG. 5, there is clear distinction between human speech and synthetically-generated speech in audio with respect to breath statistics related to average breaths per minute, average breath duration, and average breath spacing. As such, the synthetic speech detection model 110 can provide improved detection of deepfake audio by utilizing the one or more breath events 109 to determine features related to average breaths per minute, average breath duration, and/or average spacing between breaths, thereby improving accuracy of the speech classification 111 related to the one or more audio samples 102.

### Exemplary Methods for Detecting Audio Deepfakes Using Breath Events

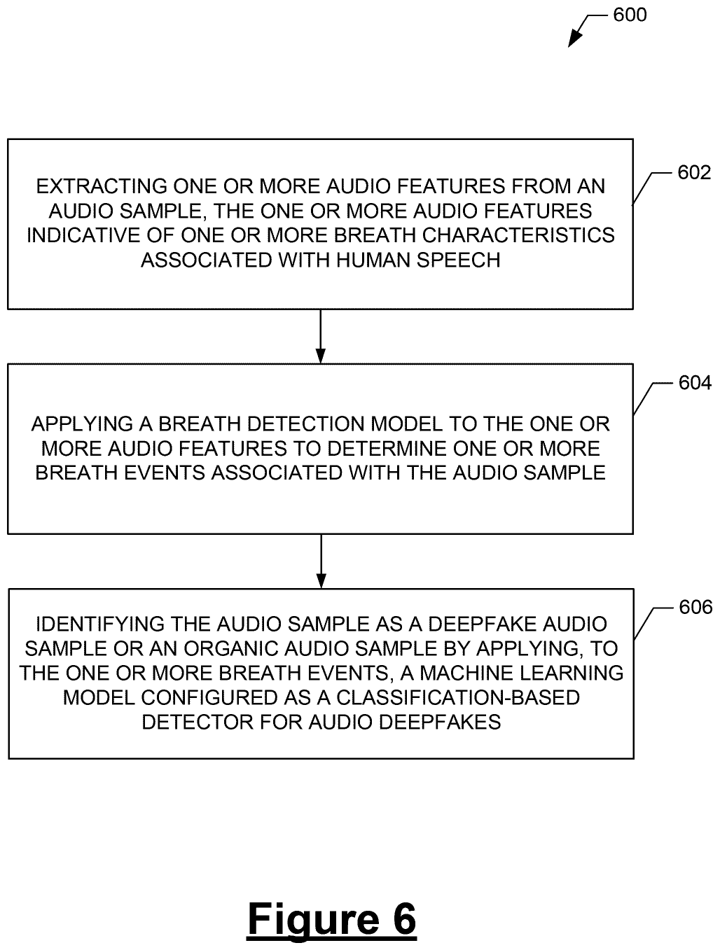

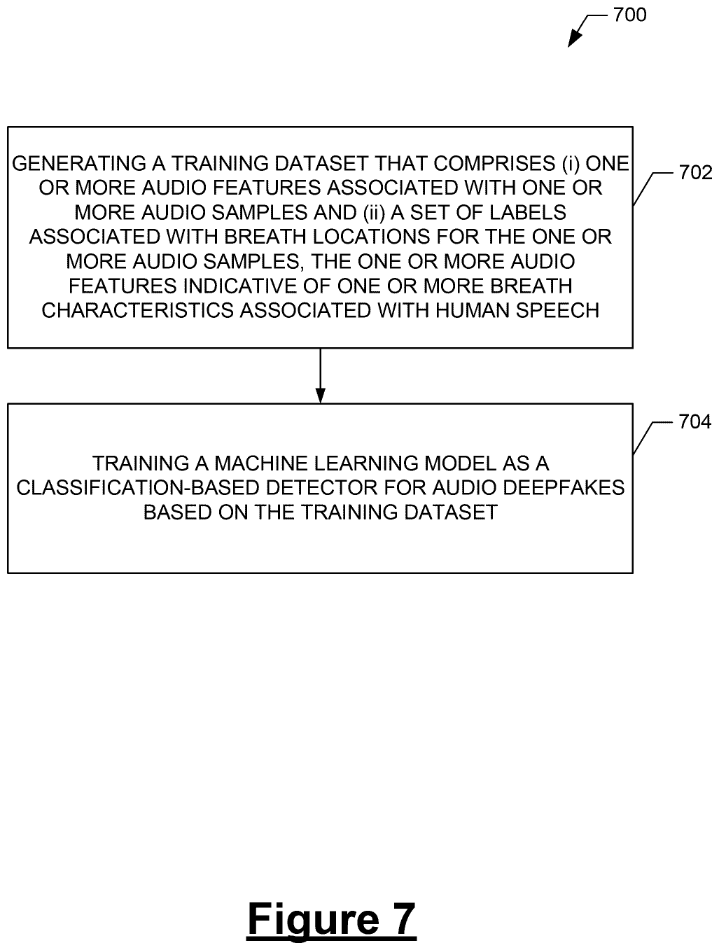

FIG. 6 and FIG. 7 illustrate a flowchart depicting methods according to example embodiments of the present disclosure. It will be understood that each block of the flowchart and combination of blocks in the flowchart may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory device of an apparatus employing an embodiment of the present disclosure and executed by a processor of the apparatus. As will be appreciated, any such computer program instructions may be loaded onto a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions that execute on the computer or other programmable apparatus provide operations for implementing the functions specified in the flowchart blocks.

Accordingly, blocks of the flowchart support combinations of means for performing the specified functions and combinations of operations for performing the specified functions for performing the specified functions. It will also be understood that one or more blocks of the flowchart, and combinations of blocks in the flowchart, can be implemented by special purpose hardware-based computer systems that perform the specified functions, or combinations of special purpose hardware and computer instructions.

FIG. 6 illustrates a flowchart of a method 600 for detecting audio deepfakes using breath events according to one or more embodiments of the present disclosure. According to the illustrated embodiment, one or more audio features are extracted at 602 from an audio sample. The one or more audio features indicative of one or more breath characteristics associated with human speech. Additionally, a breath detection model is applied to the one or more audio features at 604 to determine one or more breath events associated with the audio sample. Additionally, the audio sample is identified as a deepfake audio sample or an organic audio sample at 606 by applying, to the one or more breath events, a machine learning model configured as a classification-based detector for audio deepfakes. In one or more embodiments, the one or more audio features are scaled for processing by the machine learning model. In one or more embodiments, the machine learning model is configured as a deep learning model, a neural network model, an MLP model, a kNN model, an RFC model, an SVM, a DNN model, or another type of machine learning model configured as a classification-based detector for audio deepfakes. In one or more embodiments, the machine learning model is a first machine learning model and the breath detection model is a second machine learning model. For example, the breath detection model may be configured as a deep learning model, a neural network model, an MLP model, a kNN model, an RFC model, an SVM, a DNN model, or another type of machine learning model configured for breath detection.

In one or more embodiments, the one or more audio features are related to ZCR characteristics of the audio sample. Additionally or alternatively, in one or more embodiments, the one or more audio features are related to RMSE characteristics of the audio sample. Additionally or alternatively, in one or more embodiments, the one or more audio features are related to Mel spectrogram characteristics of the audio sample.

In one or more embodiments, breath features related to average breaths per an interval of time, average breath duration, and/or average spacing between breaths are determined based on the one or more breath events. For example, identifying the audio sample as the deepfake audio sample or the organic audio sample may include determining breath features related to average breaths per an interval of time based on the one or more breath events. Additionally or alternatively, identifying the audio sample as the deepfake audio sample or the organic audio sample may include determining breath features related to average breath duration based on the one or more breath events. Additionally or alternatively, identifying the audio sample as the deepfake audio sample or the organic audio sample may include determining breath features related to average spacing between breaths based on the one or more breath events. In one or more embodiments, the machine learning model is applied to the breath features to identify the audio sample as a deepfake audio sample or an organic audio sample. For example, a SVC technique can be applied to the breath features to identify the audio sample as a deepfake audio sample or an organic audio sample.

FIG. 7 illustrates a flowchart of a method 700 for training a machine learning model for detecting audio deepfakes according to one or more embodiments of the present disclosure. According to the illustrated embodiment, a training dataset that comprises (i) one or more audio features associated with one or more audio samples and (ii) a set of labels associated with breath locations for the one or more audio samples is generated at 702. In one or more embodiments, the one or more audio features are indicative of one or more breath characteristics associated with human speech. The one or more audio features indicative of one or more breath characteristics associated with human speech. Additionally, a machine learning model is trained at 704 as a classification-based detector for audio deepfakes based on the training dataset.

In one or more embodiments, the one or more audio features are related to ZCR characteristics of the one or more audio samples. Additionally or alternatively, in one or more embodiments, the one or more audio features are related to RMSE characteristics of the one or more audio samples. Additionally or alternatively, in one or more embodiments, the one or more audio features are related to Mel spectrogram characteristics of the one or more audio samples.

In one or more embodiments, the one or more audio features are scaled for processing by the machine learning model.

In one or more embodiments, the set of labels included in the training dataset are annotated for breath locations. Additionally, the machine learning model can be trained to predict the breath locations.

In one or more embodiments, the one or more audio samples can be filtered via one or more denoising techniques to provide audio samples with minimal noise. Additionally, in one or more embodiments, breathing events in the one or more audio samples may be evident and/or detectable. In one or more embodiments, the machine learning model may be repeatedly trained via two or more training stages until the machine learning model is capable of discriminating between real speech samples (e.g., an organic audio sample) and synthetic speech samples (e.g., a deepfake audio sample).

In one or more embodiments, the machine learning model is configured as a deep learning model, a neural network model, an MLP model, a kNN model, an RFC model, an SVM, a DNN model, or another type of machine learning model.

### Exemplary Technical Implementation of Various Embodiments

Embodiments of the present disclosure may be implemented in various ways, including as computer program products that comprise articles of manufacture. Such computer program products may include one or more software components including, for example, software objects, methods, data structures, and/or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM)), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for, or used in addition to, the computer-readable storage media described above.

As should be appreciated, various embodiments of the present disclosure may also be implemented as methods, apparatus, systems, computing devices, computing entities, and/or the like. As such, embodiments of the present disclosure may take the form of a data structure, apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises a combination of computer program products and hardware performing certain steps or operations.

Embodiments of the present disclosure are described with reference to example operations, steps, processes, blocks, and/or the like. Thus, it should be understood that each operation, step, process, block, and/or the like may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically configured machines performing the steps or operations specified in the block diagrams and flowchart illustrations. Accordingly, the block diagrams and flowchart illustrations support various combinations of embodiments for performing the specified instructions, operations, or steps.

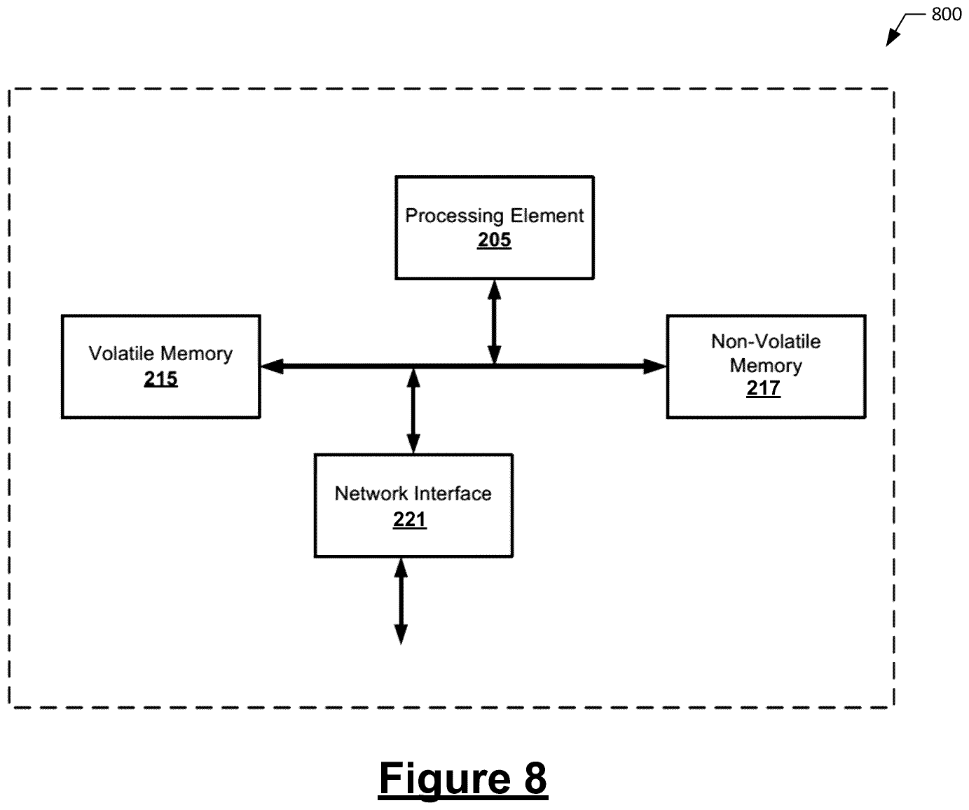

FIG. 8 provides a schematic of an exemplary apparatus 800 that may be used in accordance with various embodiments of the present disclosure. In particular, the apparatus 800 may be configured to perform various example operations described herein to provide for detecting audio deepfakes using breath events.

In general, the terms computing entity, entity, device, and/or similar words used herein interchangeably may refer to, for example, one or more computers, computing entities, desktop computers, mobile phones, tablets, phablets, notebooks, laptops, distributed systems, items/devices, terminals, servers or server networks, blades, gateways, switches, processing devices, processing entities, set-top boxes, relays, routers, network access points, base stations, or the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably.

Although illustrated as a single computing entity, those of ordinary skill in the field should appreciate that the apparatus 800 shown in FIG. 8 may be embodied as a plurality of computing entities, tools, and/or the like operating collectively to perform one or more processes, methods, and/or steps. As just one non-limiting example, the apparatus 800 may comprise a plurality of individual data tools, each of which may perform specified tasks and/or processes.

Depending on the embodiment, the apparatus 800 may include one or more network and/or communications interfaces 221 for communicating with various computing entities, such as by communicating data, content, information, and/or similar terms used herein interchangeably that can be transmitted, received, operated on, processed, displayed, stored, and/or the like. Thus, in certain embodiments, the apparatus 800 may be configured to receive data from one or more data sources and/or devices as well as receive data indicative of input, for example, from a device.

The networks used for communicating may include, but are not limited to, any one or a combination of different types of suitable communications networks such as, for example, cable networks, public networks (e.g., the Internet), private networks (e.g., frame-relay networks), wireless networks, cellular networks, telephone networks (e.g., a public switched telephone network), or any other suitable private and/or public networks. Further, the networks may have any suitable communication range associated therewith and may include, for example, global networks (e.g., the Internet), MANs, WANs, LANs, or PANs. In addition, the networks may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, satellite communication mediums, or any combination thereof, as well as a variety of network devices and computing platforms provided by network providers or other entities.

Accordingly, such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the apparatus 800 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), 5G New Radio (5G NR), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol. The apparatus 800 may use such protocols and standards to communicate using Border Gateway Protocol (BGP), Dynamic Host Configuration Protocol (DHCP), Domain Name System (DNS), File Transfer Protocol (FTP), Hypertext Transfer Protocol (HTTP), HTTP over TLS/SSL/Secure, Internet Message Access Protocol (IMAP), Network Time Protocol (NTP), Simple Mail Transfer Protocol (SMTP), Telnet, Transport Layer Security (TLS), Secure Sockets Layer (SSL), Internet Protocol (IP), Transmission Control Protocol (TCP), User Datagram Protocol (UDP), Datagram Congestion Control Protocol (DCCP), Stream Control Transmission Protocol (SCTP), HyperText Markup Language (HTML), and/or the like.

In addition, in various embodiments, the apparatus 800 includes or is in communication with one or more processing elements 205 (also referred to as processors, processing circuitry, and/or similar terms used herein interchangeably) that communicate with other elements within the apparatus 800 via a bus, for example, or network connection. As will be understood, the processing element 205 may be embodied in several different ways. For example, the processing element 205 may be embodied as one or more complex programmable logic devices (CPLDs), microprocessors, multi-core processors, coprocessing entities, application-specific instruction-set processors (ASIPs), and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like.

As will therefore be understood, the processing element 205 may be configured for a particular use or configured to execute instructions stored in volatile or non-volatile media or otherwise accessible to the processing element 205. As such, whether configured by hardware, computer program products, or a combination thereof, the processing element 205 may be capable of performing steps or operations according to embodiments of the present disclosure when configured accordingly.

In various embodiments, the apparatus 800 may include or be in communication with non-volatile media (also referred to as non-volatile storage, memory, memory storage, memory circuitry and/or similar terms used herein interchangeably). For instance, the non-volatile storage or memory may include one or more non-volatile storage or non-volatile memory media 217 such as hard disks, ROM, PROM, EPROM, EEPROM, flash memory, MMCs, SD memory cards, Memory Sticks, CBRAM, PRAM, FeRAM, RRAM, SONOS, racetrack memory, and/or the like. As will be recognized, the non-volatile storage or non-volatile memory media 217 may store files, databases, database instances, database management system entities, images, data, applications, programs, program modules, scripts, source code, object code, byte code, compiled code, interpreted code, machine code, executable instructions, and/or the like. The term database, database instance, database management system entity, and/or similar terms used herein interchangeably and in a general sense refer to a structured or unstructured collection of information/data that is stored in a computer-readable storage medium.

In particular embodiments, the non-volatile memory media 217 may also be embodied as a data storage device or devices, as a separate database server or servers, or as a combination of data storage devices and separate database servers. Further, in some embodiments, the non-volatile memory media 217 may be embodied as a distributed repository such that some of the stored information/data is stored centrally in a location within the system and other information/data is stored in one or more remote locations. Alternatively, in some embodiments, the distributed repository may be distributed over a plurality of remote storage locations only. As already discussed, various embodiments contemplated herein use data storage in which some or all the information/data required for various embodiments of the disclosure may be stored.

In various embodiments, the apparatus 800 may further include or be in communication with volatile media (also referred to as volatile storage, memory, memory storage, memory circuitry and/or similar terms used herein interchangeably). For instance, the volatile storage or memory may also include one or more volatile storage or volatile memory media 215 as described above, such as RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like.

As will be recognized, the volatile storage or volatile memory media 215 may be used to store at least portions of the databases, database instances, database management system entities, data, images, applications, programs, program modules, scripts, source code, object code, byte code, compiled code, interpreted code, machine code, executable instructions, and/or the like being executed by, for example, the processing element 205. Thus, the databases, database instances, database management system entities, data, images, applications, programs, program modules, scripts, source code, object code, byte code, compiled code, interpreted code, machine code, executable instructions, and/or the like may be used to control certain aspects of the operation of the apparatus 800 with the assistance of the processing element 205 and operating system.

As will be appreciated, one or more of the computing entity's components may be located remotely from the other computing entity components, such as in a distributed system. Furthermore, one or more of the components may be aggregated, and additional components performing functions described herein may be included in the apparatus 800. Thus, the apparatus 800 can be adapted to accommodate a variety of needs and circumstances.

### CONCLUSION

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A method for detecting audio deepfakes using breath events, comprising:
extracting one or more audio features from an audio sample, the one or more audio features indicative of one or more breath characteristics associated with human speech;
applying a breath detection model to the one or more audio features to determine one or more breath events associated with the audio sample; and
identifying the audio sample as a deepfake audio sample or an organic audio sample by applying, to the one or more breath events, a machine learning model configured as a classification-based detector for audio deepfakes.

2. The method of claim 1, wherein the one or more audio features are related to zero crossing rate (ZCR) characteristics of the audio sample.

3. The method of claim 1, wherein the one or more audio features are related to root mean squared energy (RMSE) characteristics of the audio sample.

4. The method of claim 1, wherein the one or more audio features are related Mel spectrogram characteristics of the audio sample.

5. The method of claim 1, wherein the one or more breath events correspond to respective breath locations within the audio sample.

6. The method of claim 1, wherein identifying the audio sample as the deepfake audio sample or the organic audio sample comprises:
determining breath features related to average breaths per an interval of time based on the one or more breath events; and
applying a support vector classification (SVC) technique to the breath features to identify the audio sample as a deepfake audio sample or an organic audio sample.

7. The method of claim 1, wherein identifying the audio sample as the deepfake audio sample or the organic audio sample comprises:
determining breath features related to average breath duration based on the one or more breath events; and
applying a support vector classification (SVC) technique to the breath features to identify the audio sample as a deepfake audio sample or an organic audio sample.

8. The method of claim 1, wherein identifying the audio sample as the deepfake audio sample or the organic audio sample comprises:
determining breath features related to average spacing between breaths based on the one or more breath events; and
applying a support vector classification (SVC) technique to the breath features to identify the audio sample as a deepfake audio sample or an organic audio sample.

9. The method of claim 1, wherein identifying the audio sample as the deepfake audio sample or the organic audio sample comprises:
determining breath features related to average breaths per an interval of time, average breath duration, and average spacing between breaths based on the one or more breath events; and
applying a support vector classification (SVC) technique to the breath features to identify the audio sample as a deepfake audio sample or an organic audio sample.

10. The method of claim 1, wherein the machine learning model is a first machine learning model and the breath detection model is a second machine learning model.

11. An apparatus for detecting audio deepfakes using breath events, the apparatus comprising at least one processor and at least one memory including program code, the at least one memory and the program code configured to, with the at least one processor, cause the apparatus to at least:
extract one or more audio features from an audio sample, the one or more audio features indicative of one or more breath characteristics associated with human speech;
apply a breath detection model to the one or more audio features to determine one or more breath events associated with the audio sample; and
identify the audio sample as a deepfake audio sample or an organic audio sample by applying, to the one or more breath events, a machine learning model configured as a classification-based detector for audio deepfakes.

12. The apparatus of claim 11, wherein the one or more audio features are related to zero crossing rate (ZCR) characteristics of the audio sample.

13. The apparatus of claim 11, wherein the one or more audio features are related to root mean squared energy (RMSE) characteristics of the audio sample.

14. The apparatus of claim 11, wherein the one or more audio features are related Mel spectrogram characteristics of the audio sample.

15. The apparatus of claim 11, wherein the one or more breath events correspond to respective breath locations within the audio sample.

16. The apparatus of claim 11, wherein the at least one memory and the program code are configured to, with the at least one processor, further cause the apparatus to at least:
determine breath features related to average breaths per an interval of time, average breath duration, or average spacing between breaths based on the one or more breath events; and
apply a support vector classification (SVC) technique to the breath features to identify the audio sample as a deepfake audio sample or an organic audio sample.

17. The apparatus of claim 11, wherein the machine learning model is a first machine learning model and the breath detection model is a second machine learning model.

18. A non-transitory computer storage medium comprising instructions for detecting audio deepfakes using breath events, the instructions being configured to cause one or more processors to at least perform operations configured to:
extract one or more audio features from an audio sample, the one or more audio features indicative of one or more breath characteristics associated with human speech;
apply a breath detection model to the one or more audio features to determine one or more breath events associated with the audio sample; and
identify the audio sample as a deepfake audio sample or an organic audio sample by applying, to the one or more breath events, a machine learning model configured as a classification-based detector for audio deepfakes.

19. The non-transitory computer storage medium of claim 18, wherein the operations are further configured to:
determine breath features related to average breaths per an interval of time, average breath duration, or average spacing between breaths based on the one or more breath events; and
apply a support vector classification (SVC) technique to the breath features to identify the audio sample as a deepfake audio sample or an organic audio sample.

20. The non-transitory computer storage medium of claim 18, wherein the machine learning model is a first machine learning model and the breath detection model is a second machine learning model.
